(19) United States
(12) Patent Application Publication
(10) Pub. No.: US 2025/0047467 A1
(43) Pub. Date: Feb. 6, 2025

(54) AES CRYPTOGRAPHIC SYSTEM AND METHOD

(71) Applicant: Agency for Science, Technology and Research, Singapore (SG)

(72) Inventors: Ming Ming WONG, Singapore (SG); Jayce Lay Keng LIM, Singapore (SG); Anh Tuan DO, Singapore (SG)

(21) Appl. No.: 18/716,369

(22) PCT Filed: Dec. 5, 2022
(86) PCT No.: PCT/SG2022/050885

§ 371 Date: Jun. 4, 2024

(30) Foreign Application Priority Data
Dec. 9, 2021 (SG) 10202113695S

(51) Int. Cl. H04L 9/06

(52) U.S. Cl. CPC H04L 9/0631

(57) ABSTRACT

An Advanced Encryption Standard (AES) cryptographic system and a method of performing Advanced Encryption Standard (AES) cryptography. The method comprises the steps of performing multiplicative inversion for SubBytes transformation using two forward-reverse linear-feedback shift registers, LFSRs, pairs; and using different respective initialization seeds for the pairs of forward-reverse LFSRs.

### FIELD OF INVENTION

The present invention relates broadly to and advanced Encryption Standard (AES) cryptographic system and method, in particular to side-channel attack resilient AES using LFSR-based S-box.

### BACKGROUND

Any mention and/or discussion of prior art throughout the specification should not be considered, in any way, as an admission that this prior art is well known or forms part of common general knowledge in the field.

Advanced Encryption Standard (AES) is the symmetric block cipher standard announced by the National Institute of Standards and Technology (NIST) in November 2001. AES has the structure of Substitution Permutation Network (SPN) and its computational flow (encryption/decryption) requires several rounds of iterations such as shown in FIG. 1. Each computation round consists of four main transformations which are the SubByte, ShiftRow, MixColumn and AddRoundKey.

Despite of its security hardness and high tolerance against cryptanalysis, AES is known to be vulnerable against Side-Channel Attack (SCA). SCA is capable of retrieving the secret information (i.e. secret key) from the AES by correlating the device's physical leakage and the known intermediate data from the encryption process. This physical leakage, or also known as side-channel leakage, can be in the form of power dissipation, electromagnetic (EM) emanation, timing or acoustic. Among these, power and EM are the two main physical leakages exploited in SCA due to the efficiency and the simplicity of the physical measurement.

The existence of the linear relationship between the side-channel information and the intermediate values in encryption process has made correlation power analysis (CPA) attack and correlation electromagnetic analysis (CEMA) attack the effective and efficient tools in SCA. Both analyses reveal the secret key by analysing the statistical properties (correlation coefficients) between the intermediate values of the encryption and the measured (power/EM) traces.

Among all the transformation rounds in AES (refer FIG. 1), the SubBytes, or also commonly known as S-box, is the sole non-linear operation in AES. S-box plays a crucial role in creating the confusion effect in the cipher. However, at the same time, its computation tends to leak side-channels which can be exploited in CPA attacks. To explain further, the peak amplitudes in the power waveform observed during AES operation (executed with different plaintexts) form as the source of side-channel leakage such as shown in FIG. 2. The voltage drops in the last round of AES operation (in the span of 15 ns shown in FIG. 2) is correlated with the Hamming distance between before and after the AES computation. The (peak) amplitudes of the power waveform varies with different input plaintexts due to the toggling effect in the internal logic. Therefore, SCA uses the correlation between the observable voltage drop and the Hamming distance to reveal the secret key.

Furthermore, the leakage severity is also dependent on the design choices of the S-box in hardware as different circuit architecture will have different internal toggling effect.

AES transformation rounds are performed on two-dimensional array of 4×4 bytes (refer FIG. 1), which is termed as State. Based on AES specification, these transformation rounds are computed over the Galois field GF(2⁸) which is constructed using the field polynomial stated in Eqn. 1.

$$q ( x ) = {x}^{8} + {x}^{4} + {x}^{3} + x + 1 \qquad ( 1 )$$

The non-linear operation in AES, S-box performs multiplicative inversion over GF(2⁸) and followed by affine transformation. Though affine transformation is relatively simple in implementation, multiplicative inversion of higher order requires tedious computation. Therefore, S-box is regarded as the bottleneck of AES in achieving compact and low power implementation. As a result, several works have proposed different designs for S-box hardware implementation. Overall, these designs can be broadly categorized in two types: (i) using memory storage such as Look-up Table (LUT) and (ii) using pure combinational circuit via Composite Field Arithmetic (CFA).

Use of linear-feedback shift register (LFSR) has also been proposed for S-box implementation, but there remain limitations in the maximum total execution time and side channel attack resilience. [Sourav Das. Halka: A lightweight, software friendly block cipher using ultra-lightweight 8-bit s-box. IACR Cryptology ePrint Archive, 2014:110, 2014] and [Sourav Das. Ultra-lightweight 8-bit multiplicative inverse based s-box using lfsr. IACR Cryptology ePrint Archive, 2014:22, 2014] described use of a single LFSR executed twice (repeated), sharing the same initialization seed. The total execution time is fixed, T=255 clk cycles. [M. M. Wong and M. L. D. Wong. New lightweight aes s-box using lfsr. In 2014 International Symposium on Intelligent Signal Processing and Communication Systems (ISPACS), pages 115-120, 2014] and [M. M. Wong and M. L. D. Wong. Lfsr based s-box for lightweight cryptographic implementation. In 2015 IEEE International Conference on Consumer Electronics-Taiwan, pages 498-499, 2015] described use of double LSFRs executed concurrently, sharing the same initialization seed. The total execution time is variable, with the maximum, Tmax=127 clk cycles.

Embodiments of the present invention seek to address at least one of the above problems and/or provide at least an alternative solution for AES computation.

### SUMMARY

In accordance with a first aspect of the present invention, there is provided an Advanced Encryption Standard (AES) cryptographic system comprising:
a SubBytes transformation unit, S-box;
a ShiftRow transformation unit;
a MixColumn transformation unit; and
an AddRoundKey transformation unit;
wherein the S-box comprises two forward-reverse linear-feedback shift registers, LFSRs, pairs for performing multiplicative inversion; and
wherein different respective initialization seeds are used for the pairs of forward-reverse LFSRs.

In accordance with a second aspect of the present invention, there is provided a method of performing Advanced Encryption Standard (AES) cryptography, comprising the steps of:
performing multiplicative inversion for SubBytes transformation using two forward-reverse linear-feedback shift registers, LFSRs, pairs; and
using different respective initialization seeds for the pairs of forward-reverse LFSRs.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows diagrams illustrating Encryption/Decryption process of AES-128 cipher.

FIG. 2 shows a graph illustrating AES power waveform and voltage drop observed in the last round of encryption [13].

FIG. 3A shows a diagram illustrating a forward Linear-Feedback Shift Register (LFSR), for use in multiplicative inversion using forward and reverse pair according to an example embodiment.

FIG. 3B shows a diagram illustrating a reverse LFSR, for use in multiplicative inversion using forward and reverse pair according to an example embodiment.

FIG. 4 shows a diagram illustrating an AES S-box using duo forward-reverse pairs LFSR according to an example embodiment.

FIG. 5 shows a graph illustrating a comparison of the average, maximum and standard deviation of the total transition cycles needed to complete multiplicative inversion using various initialization seeds between existing LFSRs and an LFSRs implemented design according to an example embodiment.

FIG. 6 shows a graph illustrating a comparison of the number of clock cycles needed to compute S-box output for all the possible subkey bytes between an example embodiment and works reported in [1,2].

FIG. 7 shows a diagram illustrating an evaluation setup for EM side-channel attack conducted on an example embodiment.

FIG. 8A shows a graph illustrating a trace pattern for LUT-based S-box operation with 10 peaks that corresponds to S-box operations in 10 transformation rounds observed in the EM waveform.

FIG. 8B shows a graph illustrating a trace pattern for combinational circuit S-box operation with 10 peaks that corresponds to S-box operations in 10 transformation rounds observed in the EM waveform.

FIG. 8C shows a graph illustrating a trace pattern for S-box operation according to an example embodiment with no peaks that corresponds to S-box operations in transformation rounds observed in the EM waveform.

FIG. 8D shows a graph illustrating Minimum Traces to Disclosure (MTD) for LUT-based S-box operation.

FIG. 8E shows a graph illustrating MTD for combinational circuit S-box operation.

FIG. 8F shows a graph illustrating MTD for S-box operation according to an example embodiment.

FIG. 8G shows a graph illustrating Partial Guess Entropy (PGE) for LUT-based S-box operation.

FIG. 8H shows a graph illustrating PGE for combinational circuit S-box operation.

FIG. 8I shows a graph illustrating PGE for S-box operation according to an example embodiment.

FIG. 9 shows a flowchart illustrating a method of performing Advanced Encryption Standard (AES) cryptography, according to an example embodiment.

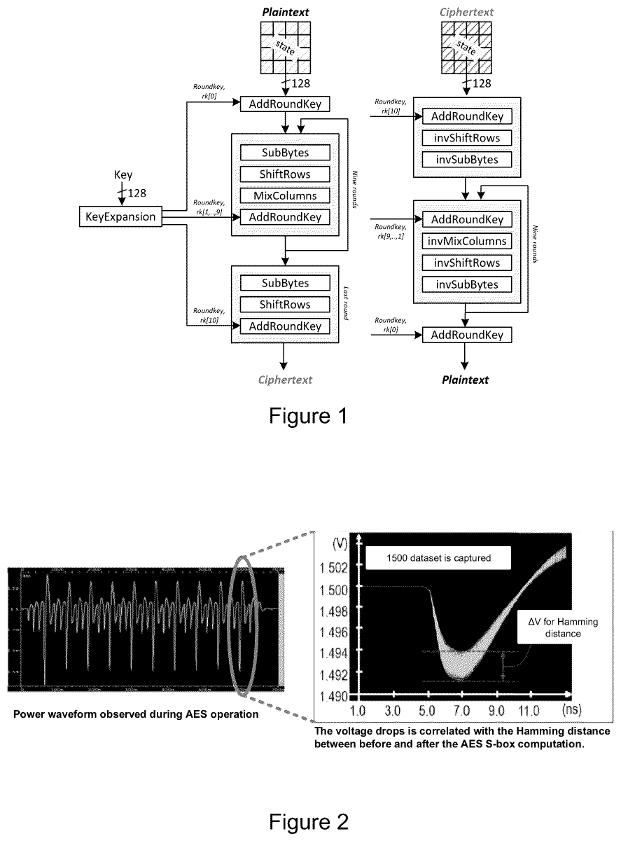

### DETAILED DESCRIPTION

An example embodiment of the present invention provides a Side-channel attack (SCA) resilient Advanced Encryption Standard (AES) S-box design that is constructed using Linear-Feedback Shift Register (LFSR). AS mentioned in the background section, existing AES engines are typically implemented using either LUT-based S-box or composite field arithmetic (CFA) based S-box, which both have been proven vulnerable against SCA. An example embodiment uses an LFSR-based multiplicative inverter, the core computation in AES S-box, with latency reduction by at least 75%. Multiple initialization seeds with variable S-box completion time that serves as side-channel leakage masking and desynchronization are presented according to an example embodiments. Using electromagnetic attack (EMA) analysis on the AES running on Nexys Artix-7 FPGA, an example embodiment shows Minimum Traces Disclosure (MTD) of >180 k traces and none of the subkeys can be retrieved. Meanwhile, all the 16 subkeys (128-bits) can be unveiled from comparative LUT-based design with MTD of 2.2 k traces and MTD of 25 k traces in CFA-based design.

Use of an example embodiment resulted in variable S-box completion time that creates time-domain desynchronization that causes misalignment in the collected side-channels.

An example embodiment provides an LFSR-based S-box which was integrated and tested on AES cipher. In addition, CPA analysis was performed on the proposed AES cipher according to an example embodiment and its higher resilience against SCA attack compared to LUT-based and CFA-based S-boxes is shown.

Multiplicative inverter over GF(2⁸) is the core computation in AES S-box function. Meanwhile, the typical LFSR-based multiplicative inverter over GF(2⁸) required a fix computational cycle of 255 cycles [1]. Preliminary Discussion on LFSR-based AES S-box Design

In cryptography domain, Linear-feedback shift register (LFSR) is used as Pseudo Random Number Generator (PRNG) for stream ciphers. Furthermore, it is also deployed in circuit testing such as signature analysis in built-in self-test (BIST) and test pattern generation. LFSR is constructed using registers and XOR gates to generate a cyclic collection of binary states. It updates the current state using a linear transformation from its previous state. In an example embodiment, instead an AES S-box implementation which is designed using LFSRs as the core computational component is provided.

As mentioned above, AES S-box computation is comprised of (i) multiplicative inversion over GF(2⁸) using field polynomial q(x) (see Eqn. 1) and followed by (ii) affine transformation. In an example embodiment, LFSR is used as the multiplicative inverter in AES S-box.

### Galois Field Mapping

In every LFSR, a polynomial function p(x), is used to define its tap position (the XOR bits). In order to obtain multiplicative inverse in GF(2ⁿ), the chosen polynomial should be able to generate 2ⁿ−1 unique states. Therefore, in this case, only primitive polynomial can be used in the LFSR. However, q(x) (refer Eqn. 1) used in AES standard is a non-primitive polynomial. Accordingly, primitive polynomial q⁰(x) stated in Eqn. 2

$${q}^{0} ( x ) = {x}^{8} + {x}^{4} + {x}^{3} + {x}^{2} + 1 \qquad ( 2 )$$

is used as the field elements generator for GF(2⁸) [3]. In doing so, the original AES S-box input has to be mapped into the representation generated by q⁰(x). This step is similar to CFA approach where isomorphism mapping is performed prior to multiplicative inversion. After multiplicative inversion, the output is reverted to its original field using inverse isomorphism mapping before performing affine transformation.
GF(2⁸) Multiplicative Inversion Over q⁰(x)

Transformation state in LFSR for v cycles can be generalized as the function stated in Eqn. 3 [2,3]. Given the LFSR's state at time t is S(t) and matrix T is the state transformation in the LFSR.

$$S ( t + v ) = {T}^{v} \cdot S ( t ) \qquad ( 3 )$$

The state transformation in Eqn. 3 enable the LFSR with primitive polynomial q⁰(x) to reach the maximum length at (2ⁿ−1)^{th} cycles (for GF (2ⁿ)), before returning to the initial state. This characteristic is an important enabler to derive multiplicative inversion in Galois Field. To explain further, for element u in GF(2⁸) that is defined in the state S(t+v), its multiplicative inverse, u⁻¹, can be found at state S(t+v⁰) such that v+v⁰=2ⁿ−1=255 and 255 is the maximum length. To summarize, LFSR performs multiplicative inversion over GF(2⁸) using the steps below.
1. LFSR starts from its initial state and stops when the input value, u, matches its current state and the state is noted as S(t+v).
2. The total cycle lapsed (from the start to the stop point), v, is counted and that v⁰=255−v is calculated.
3. The LFSR is re-initialized with the same seed and re-run for v⁰ cycles.
4. The outcome of the state S(t+v), u⁰, is the multiplicative inversion of u, where u·u⁰=1 (mod q⁰(x)).

### Latency Reduction Using Forward-Reverse LFSR Pairs According to an Example Embodiment

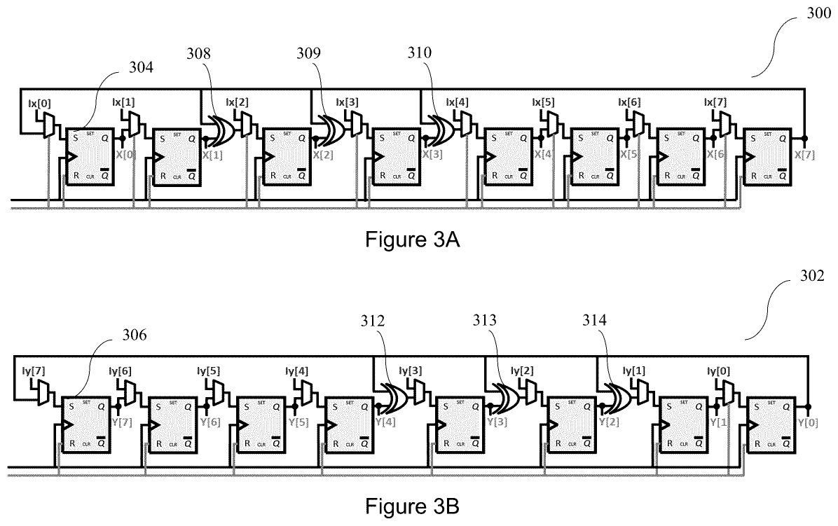

In an example embodiment, two sets of forward-reverse LFSRs pairs are used as main computational block to perform multiplicative inverse in S-box. The circuit architecture of the forward LFSR, Xᵢ, as well as the reverse LFSR, Y₁ are as depicted in FIG. 3.

The input elements are mapped to its isomorphic field generated using primitive polynomial q⁰(x). The specifications of the design according to an example embodiment are summarized in Table 2. Both the isomorphism mapping and inverse isomorphism mapping combined with affine transformation are given in Eqn. 2 and Eqn. 3 (refer in Table 2).

TABLE 2
Descriptions of LFSR pairs as multiplicative inverter GF(2⁸). These are the core components for AES S-box function.

| Details | Descriptions | |
|---|---|---|
| GF Mapping | Isomorphism: | Inverse isomorphism + affine transformation: |
| | x′ is the 8-bit representation of mapped elements | x is the 8-bit representation of elements derived in AES |
| | derived using primitive polynomial q′(x) | field polynomial g(x). |
| | $[ \begin{matrix}{x}_{7}^{′} \\ {x}_{6}^{′} \\ {x}_{5}^{′} \\ {x}_{4}^{′} \\ {x}_{3}^{′} \\ {x}_{2}^{′} \\ {x}_{1}^{′} \\ {x}_{0}^{′}\end{matrix} ] = [ \begin{matrix}1 & 0 & 0 & 0 & 0 & 0 & 0 & 0 \\ 1 & 1 & 0 & 0 & 0 & 0 & 0 & 0 \\ 1 & 0 & 1 & 0 & 0 & 0 & 0 & 0 \\ 1 & 1 & 1 & 1 & 0 & 0 & 0 & 0 \\ 1 & 0 & 0 & 0 & 1 & 0 & 0 & 0 \\ 1 & 1 & 0 & 0 & 1 & 1 & 0 & 0 \\ 1 & 0 & 1 & 0 & 1 & 0 & 1 & 0 \\ 1 & 1 & 1 & 1 & 1 & 1 & 1 & 1\end{matrix} ] \times [ \begin{matrix}{x}_{7} \\ {x}_{6} \\ {x}_{5} \\ {x}_{4} \\ {x}_{3} \\ {x}_{2} \\ {x}_{1} \\ {x}_{0}\end{matrix} ] \qquad ( 2 )$ | $[ \begin{matrix}{x}_{7} \\ {x}_{6} \\ {x}_{5} \\ {x}_{4} \\ {x}_{3} \\ {x}_{2} \\ {x}_{1} \\ {x}_{0}\end{matrix} ] = [ \begin{matrix}1 & 0 & 0 & 1 & 1 & 0 & 0 & 0 \\ 1 & 1 & 0 & 1 & 0 & 1 & 0 & 0 \\ 1 & 0 & 1 & 1 & 1 & 1 & 1 & 0 \\ 1 & 1 & 1 & 0 & 0 & 0 & 0 & 1 \\ 1 & 0 & 0 & 1 & 0 & 0 & 0 & 1 \\ 1 & 1 & 0 & 1 & 1 & 0 & 0 & 1 \\ 1 & 0 & 1 & 1 & 0 & 1 & 0 & 1 \\ 1 & 1 & 1 & 0 & 1 & 1 & 1 & 1\end{matrix} ] \times [ \begin{matrix}{x}_{7}^{′} \\ {x}_{6}^{′} \\ {x}_{5}^{′} \\ {x}_{4}^{′} \\ {x}_{3}^{′} \\ {x}_{2}^{′} \\ {x}_{1}^{′} \\ {x}_{0}^{′}\end{matrix} ] + [ \begin{matrix}0 \\ 1 \\ 1 \\ 0 \\ 0 \\ 0 \\ 1 \\ 1\end{matrix} ] \qquad ( 3 )$ |
| Discrete LFSR functions | Forward function Xᵢ[n], for i = {0, 1}: | Reverse function Yᵢ[n], for i = {0, 1}: |
| | Xᵢ[7] = Xᵢ[6]; | Yᵢ[7] = Yᵢ[0]; |
| | Xᵢ[6] = Xᵢ[5]; | Yᵢ[6] = Yᵢ[7]; |
| | Xᵢ[5] = Xᵢ[4]; | Yᵢ[5] = Yᵢ[6]; |
| | Xᵢ[4] = Xᵢ[3] ⊕ Xᵢ[7]; | Yᵢ[4] = Yᵢ[5]; |
| | Xᵢ[3] = Xᵢ[2] ⊕ Xᵢ[7]; | Yᵢ[3] = Yᵢ[4] ⊕ Yᵢ[0]; |
| | Xᵢ[2] = Xᵢ[1] ⊕ Xᵢ[7]; | Yᵢ[2] = Yᵢ[3] ⊕ Yᵢ[0]; |
| | Xᵢ[1] = Xᵢ[0]; | Yᵢ[1] = Yᵢ[2] ⊕ Yᵢ[0]; |
| | Xᵢ[0] = Xᵢ[7]; | Yᵢ[0] = Yᵢ[1]; |
| Initialization Seeds | Forward functions: | Reverse functions: |
| | IX₀:seed = {00000001}₂ = 0x01 | IY₀:seed = {00000001}₂ = 0x01 |
| | IX₁:seed = {11001100}₂ = 0xCC | IY₁:seed = {10000101}₂ = 0x85 |

### LFSR-Based AES S-Box Architecture According to an Example Embodiment

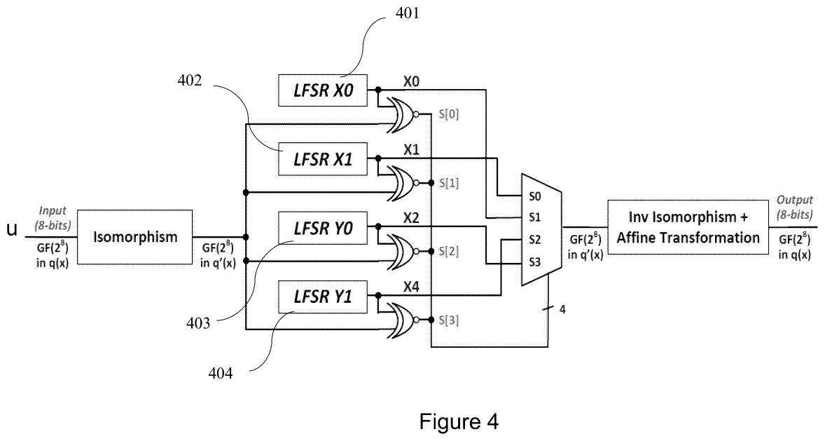

The proposed AES S-box is constructed using four 8-bit LFSRs 401-404, specifically two forward-reverse LFSRs pairs 401/403, and 402/404 (see FIG. 4), for which the functions are noted as {X₀, X₁, Y₀, Y₁} in this description. The Xᵢ LFSRs 401, 403 are shifting in forward direction, and their counterparts, Yᵢ, 402, 404 are shifting in reverse direction. In other words, 2 sets of forward-reverse LFSR pairs 401/403, and 402/404 are used as the core components of the design according to an example embodiment. Each LFSR 300, 302 is comprised of 8 registers (flip flops) e.g. 304, 306 and 3 XORs for the non-zero feedback taps, 308-310, and 312-314, as shown in FIGS. 3A and 3B. It is noted that the number of registers and XOR gate are determined based on the length of the sequence (i.e. 28=256) and the number of taps in the LFSR (i.e. 3), according to an example embodiment.

All of the Xᵢ and Yᵢ LFSRs 401-404 will be initialized with different seeds (as will be described below in detail) and executed concurrently. With the LFSRs' 401-404 state updated on every clock cycles (Xᵢ→Xᵢ⁰ and Yᵢ→Yᵢ⁰), the states readout are compared with the input, u. If a match is found in any of the LFSR 410-404, the readout from its counterpart, u⁰ will be the output (i.e. multiplicative inverse of the input). The operation flow for LFSR based multiplicative inversion is also summarized in Algorithm 1 below. The block diagram of the AES S-box execution using the design according to an example embodiment is as depicted in FIG. 4.

Algorithm 1: Multiplicative inversion GF(2⁸) with 2 forward-reverse
LFSR pairs according to an example embodiment.

Input: u ∈ GF(2⁸)
Output: u⁰ ∈ GF(2⁸)
Data: Derive u⁰ where u⁰ · u = 1

| /* Reset LFSRs with initial seeds X₀[0] ← 0x01; X₁[0] ← 0xCC; | */ |
|---|---|
| Y₀[0] ← 0x01; Y₁[0] ← 0x85; | |
| /* Update LFSRs state on every i clock cycles, where i ∈ {1,... ,63} | */ |
| /* {Xᵢ, Yᵢ} are current states, {Xᵢ⁰, Yᵢ⁰} are next states while (found 6= 1) do | */ |

```
  | X′₀[i] ← X′₀[i + 1]; X′₁[i] ← X′₁[i+ 63 + 1];
  |
```

Y′₀[i] ← Y′₀[i + 255 + 1]; Y′₁[i] ← Y′₁[i+ 191 + 1];

| end while | |
|---|---|
| /* Check for LSFR state matches input u | */ |

```
if X ₀[i]== u then
    | u⁰ ← Y₀ [i]; found ← 1;
endif
elseif X ₁[i]== u then
    | u⁰ ← Y₁[i]; found ← 1;
endif
elseif Y₀[i]== u then
    | u⁰ ← X ₀[i]; found ← 1;
endif
elseif Y₁[i]== u then
    | u⁰ ← X ₁[i]; found ← 1;
endif
```

### Multiple LFSR Initialization Seeds Analysis According to an Example Embodiment

In an example embodiment, the initialization seed for LFSR not only defines the initial state but also determines the maximum transition cycles to complete the multiplicative inversion. The initialization seed chosen in an example embodiment (refer Table 2) advantageously enables the multiplicative inversion to be completed within 63 clock cycles as opposed to 255 cycles in [2,3] or 127 cycles in [1,4].

Both single and multiple initialization seeds usage were analyzed in terms of the total transition cycles required to perform multiplicative inversion, according to various example embodiments. For the existing single initialization seed designs, the inverter operation may be described as shown in table 3A below.

In contrast, for the multiple initialization seeds design according to an example embodiment, the inverter operation may be described as shown in table 3B below.

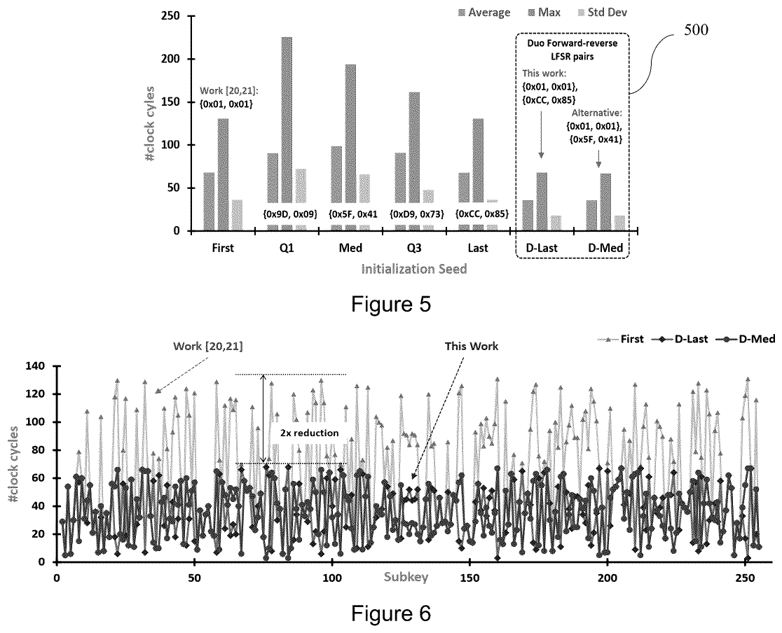

The analysis results are depicted in FIG. 5. For single seed, the LFSR is initialized using its first state (first), first quadrant of the states (Q1), mid-point of the states (Med), third quadrant of the states (Q3) and its last state (last). With single seed, the best performance was found in the usage of {0x01, 0x01}. For multiple seeds, indicated at numeral 500 (in duo forward-reverse LFSR pairs according to an example embodiment), it is evident that the average, the maximum and the standard deviation of the total transition cycles are reduced significantly. Note that, there are two sets of initialization seeds that gives equal computation performance, one of which (indicated as “this work”) was implemented in an example embodiment analyzed in more detail below, by way of example, not limitation.

Further comparison between existing works in [1,4] and the implemented example embodiment was analyzed as well. The number of clock cycles required to perform AES S-box for all the possible subkey bytes in AES was derived and is shown in FIG. 6. The result shows that the initialization seeds chosen in the implemented example embodiment has successfully reduced the Tₘₐₓ to 63. Accordingly, the use of two pairs of forward-reversed LFSR (X0-Y0, X1-Y1) according to an example embodiments leads to shorter execution time. Also, the use of three different initialization seeds on four LFSR according to an example embodiment helps to balance the power consumption during the S-box computation and thus improves the power trace masking, which enhances side channel attack protection.

### Experimental Results and SCA Analysis According to an Example Embodiment

Security hardness testings was performed between variants of S-box designs in the AES cipher. It was found that, while, the AES algorithm remained unchanged, the way the S-box is implemented (in hardware) has a significant impact towards the devices susceptibility against SCA, which will be discussed in the following.

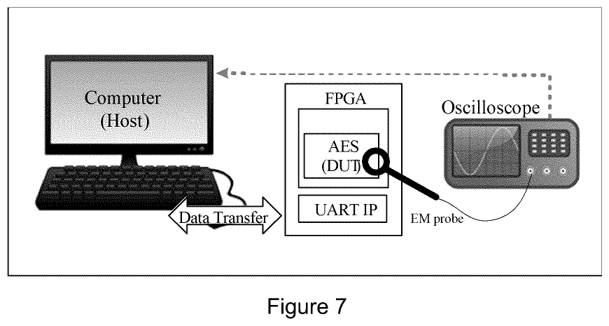

A simple hardware platform for electromagnetic (EM) side-channel acquisition was setup to measure and to collect EM waves from a device that is running AES actively. The setup is shown in FIG. 7 and the list of hardware components required is summarized in Table 4.

TABLE 4
Components for SCA evaluation setup with general
functionality description.

| No. | Item | Description |
|---|---|---|
| 1 | Evaluation board | Perform as AES hardware stand-alone |
| | FPGA (Artix 7 | accelerator and this will be the device under |
| | or other board of | testing (DUT). |
| | choice) | Receiving plaintext from PC (host) and |
| | | transmitting ciphertext back to PC (host). |
| 2 | USB 2.0 A-Male | Power supply to the evaluation board. |
| | to Micro | Connect the evaluation board to a personal |
| | B Cable | computer for data communication. |
| 3 | Electromagnetic | Acquire the EM side channel from DUT chip |
| | (EM) probes | running AES. |
| | with amplifier | Coil shaped probe with the diameter not larger |
| | | than the DUT. |
| 4 | Oscilloscope | Collect and save waveform traces for attack |
| | | analysis. |
| 5 | Computer (Host) | Transmit/Receive data to DUT that perform |
| | | encryption. |
| | | Perform side channel analysis using the traces |
| | | collected/accessed from oscilloscope. |

The side-channel acquisition methodology is summarized in the following.
1. The software from the Host initiated encryption process and send input plaintext to the FPGA.
2. The AES(device under testing, DUT) will perform encryption continuously and send the output ciphertext back to the Host.
3. While the encryption is running, EM probe is used to sense the EM wave emitted from the FPGA chip. The observed EM traces are connected to the Oscilloscope.
4. The Host accessed the traces from the Oscilloscope to perform SCA together with the input plaintext and output ciphertext.

For SCA analysis, the testing is focused on last round attack and using Hamming Distance power model. It is observed that first round attack and Hamming Weight power model is not effective on an example embodiment even with traces >100 k. Using the collected EM traces, the traces magnitude is correlated with intermediate value of AES, which is the S-box output in the last round. Note that AES has 128-bit key (16 subkey bytes). Therefore, all the 16 subkey has to be revealed without errors in order to be considered as successful breaking.

SCA analysis outcome reflected the security hardness of the implemented AES according to an example embodiment. The measurement metrics or observations that are important for this analysis are:
1. Trace pattern. The existence of the side-channel leakage can be observed in the collected EM waveform (traces). In AES, the S-box operation tends to leak side-channel and with that 10 peaks that corresponds to S-box operations in 10 transformation round can be observed in the EM waveform.
2. Minimum Traces to Disclosure (MTD). MTD is the minimum number of traces required to unveil all the 16 subkey bytes. With that, lower MTD value indicates the device is less secure against SCA.
3. Partial Guess Entropy (PGE). PGE is the analysis to check the validity of the calculated MTD. Only when PGE value consistently remained at PGE=0 (with respect to traces at MTD and above), it is safe to assume all the subkey guess can be revealed (without any wrong guesses).

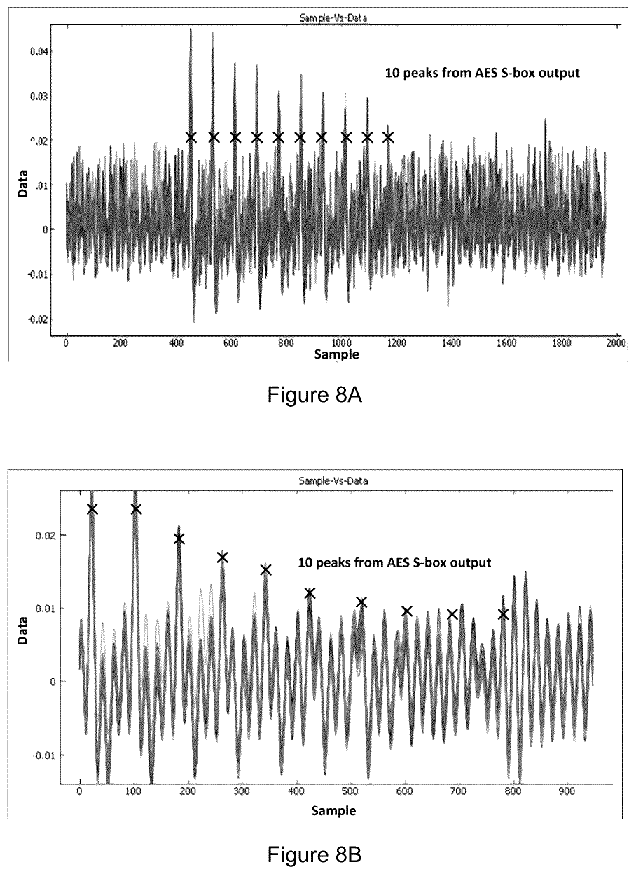

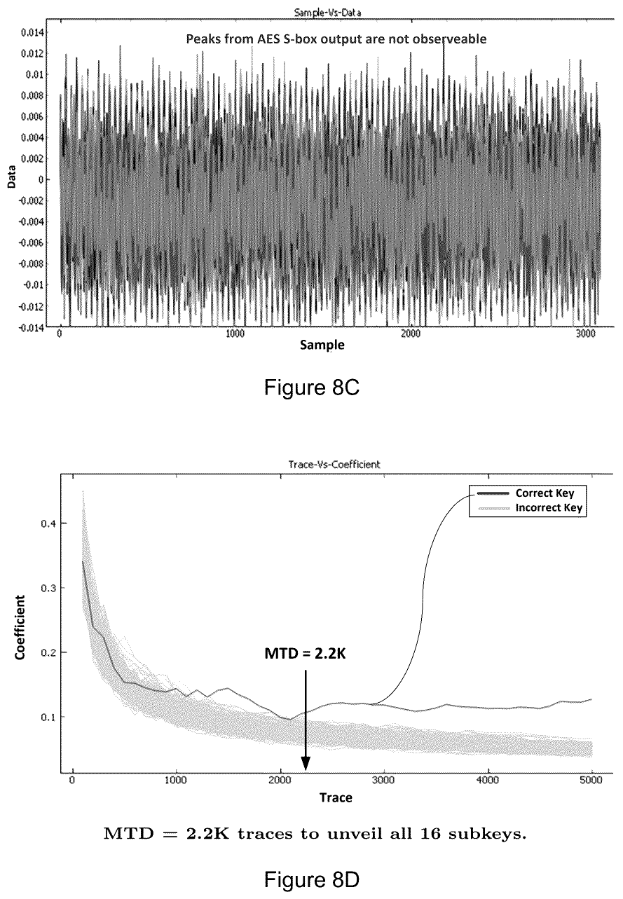

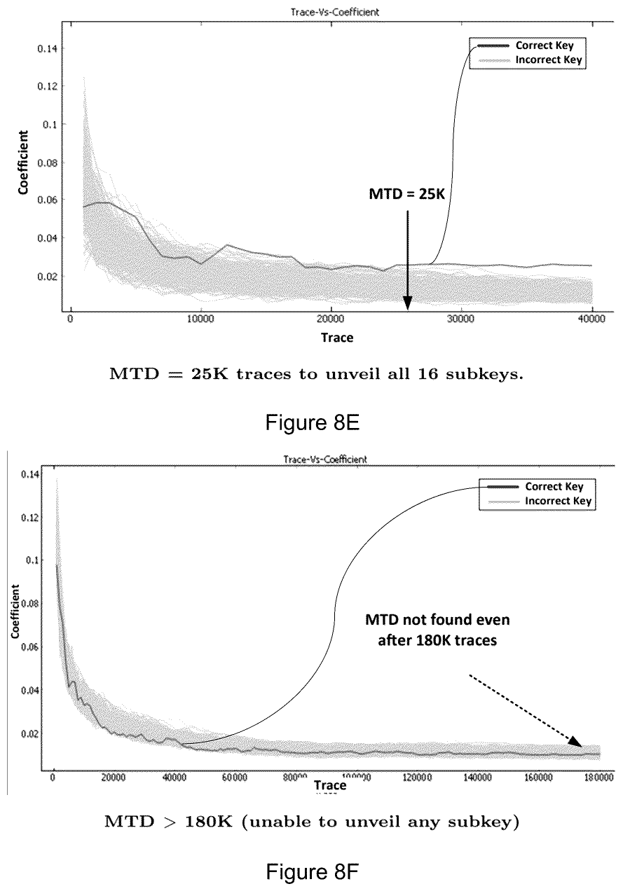

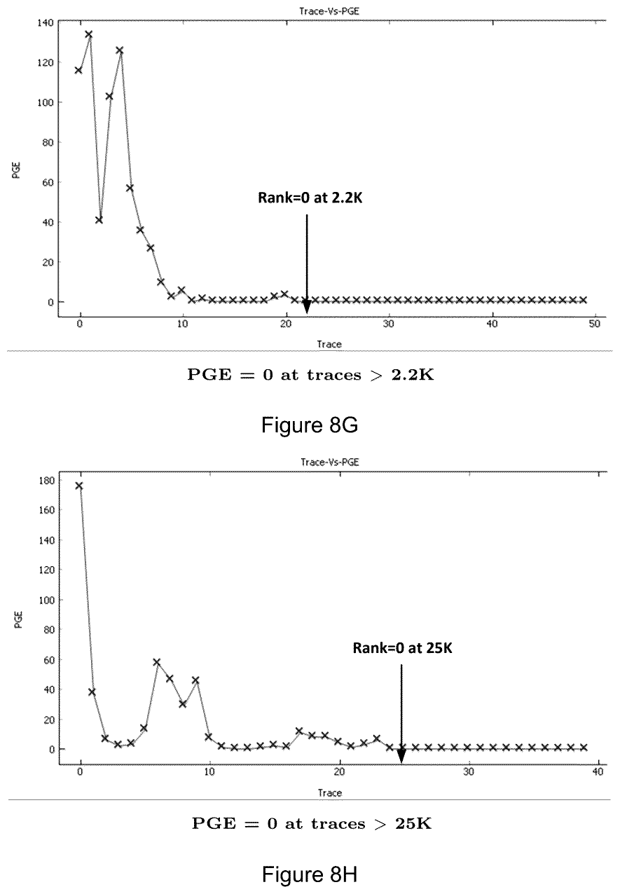

The overall SCA analysis for AES with three different S-box designs is shown in the graphs in FIGS. 8A to I. For fair comparison, the same AES implementation is used for all the three different S-box test cases. The results show that the S-box design according to an example embodiment shows now discernable peaks in the AES S-box output (see FIG. 8C) compared to LUT-based S-box (10 peaks, see FIG. 8A) and combinational circuit S-box (10 peaks, see FIG. 8B), and has the highest security hardness with MTD exceeding 180 k traces (see FIG. 8F) compared to the LUT-based S-box (MTD=2.2 k, see FIG. 8D) and combinational circuit S-box (MTD=25 k, see FIG. 8E). Furthermore, based on the MTD plot of the design according to an example embodiment, the correlation coefficient of the correct key guess shows no indication that it will surpass the rest of the key guess even as the number of traces increases, see FIG. 8I. In contrast, for LUT-based S-box PGE consistently zero is reached at 2.2 k traces, and for combinational circuit S-box PGE consistently zero is reached at 25 k traces This shows that there is no leakage (or at least no useful leakage) information that can be deployed to unveil the secret key.

The overall hardware utilization and the performance of the compared AES S-box designs that were used for SCA is summarized in Table 6 below. The comparison was evaluated in terms of the total area utilization, power consumption and critical path latency. For fair comparison, all the designs are implemented using Xilinx Vivado design tool and the functionality is tested as AES engine on Nexys Artix-7 FPGA board.

Based on the results presented herein, the CFA-based AES S-box design has the least hardware utilization which is as expected as the design is pure combinational design without using any memory storage. However, the design has 28.9% higher power consumption than the LUT-based design due the to toggling activities from the internal logic gates. Furthermore, the CFA-based AES S-box design circuit has the longest critical path, that is ×1.48 longer than LUT-based design's critical path. This also leads to the lowest performance frequency among all the three designs. The LFSR-based AES S-box according to an example embodiment has the highest area utilization which is mainly contributed from the flip-flops in the LFSRs. The critical path is comparable to the LUT-based design and is only ×0.70 of the CFA-based design. As mentioned, the LFSR-based AES S-box according to an example embodiment does advantageously show the highest SCA resistance MTD>180 k.

TABLE 6
Hardware cost utilization (area and power) and the performance
(speed) of three different AES S-box designs. The designs are
implemented using Xilinx Vivado design tool and tested as on
Nexys Artix-7 evaluation board.

| AES S-box | Area | | Critical | |
|---|---|---|---|---|
| Design | (FPGA LUT) | Power | Path | Remarks |
| LUT-based | 40 | 0.173 | 5.0 ns | Highest performance |
| | | mW | | Lowest SCA resistance |
| | | | | MTD = 2.2k |
| CFA-based | 32 | 0.223 | 7.4 ns | Most compact design |
| [14] | | mW | | Longest critical path |
| | | | | Medium SCA |
| | | | | resistanceMTD = 25k |
| | | | | traces |
| LFSR-based | 76 | 0.230 | 5.2 ns | Largest area utilization |
| (This Work) | | mW | | Highest SCA resistance |
| | | | | MTD > 180k |

In one embodiment, an Advanced Encryption Standard (AES) cryptographic system is provided, comprising a SubBytes transformation unit, S-box; a ShiftRow transformation unit; a MixColumn transformation unit; and an AddRoundKey transformation unit; wherein the S-box comprises two forward-reverse linear-feedback shift registers, LFSRs, pairs for performing multiplicative inversion; and wherein different respective initialization seeds are used for the pairs of forward-reverse LFSRs.

Each LFSR may comprise a plurality of registers and a plurality of exclusive or gates, XORs, for non-zero feedback taps. Each LFSR may comprise eight registers and three XORs for the non-zero feedback taps.

The two pairs of forward-reverse LFTRs may be executed concurrently for performing the multiplicative inversion. The multiplicative inversion may be completed within 63 clock cycles. Peaks in an amplitude versus sampling point traces plot during performing the multiplicative inversion may be masked. A Minimum Traces Disclosure plot for correct key guess may exceed 180 k traces.

The different respective initialization seeds may comprise {0x01, 0x01} and {0xCC, 0x85}.

The different respective initialization seeds may comprise {0x01, 0x01} and {0x5F, 0x41}.

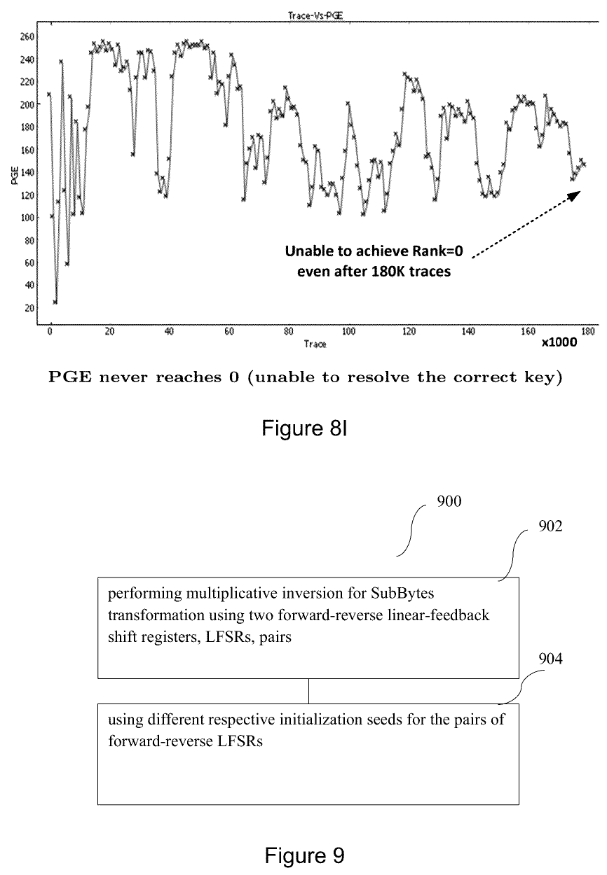

FIG. 9 shows a flowchart 900 illustrating a method of performing Advanced Encryption Standard (AES) cryptography, according to an example embodiment. At step 902, multiplicative inversion for SubBytes transformation is performed using two forward-reverse linear-feedback shift registers, LFSRs, pairs. At step 904, different respective initialization seeds are used for the pairs of forward-reverse LFSRs.

Each LFSR may comprise a plurality of registers and a plurality of exclusive or gates, XORs, for non-zero feedback taps. Each LFSR may comprise eight registers and three XORs for the non-zero feedback taps.

The method may comprise executing the two pairs of forward-reverse LFTRs concurrently for performing the multiplicative inversion. The multiplicative inversion may be completed within 63 clock cycles. Peaks in an amplitude versus sampling point traces plot during performing the multiplicative inversion may be masked. A Minimum Traces Disclosure plot for correct key guess may exceed 180 k traces.

The different respective initialization seeds used may comprise {0x01, 0x01} and {0xCC, 0x85}.

The different respective initialization seeds used may comprise {0x01, 0x01} and {0x5F, 0x41}.

As described herein, an AES S-box design that is based on two sets of forward-reverse LFSRs pairs is provided according to an example embodiment. The design according to an implemented example embodiment is proven insusceptible against SCA where using up to 180 k EM trace is still unable to retrieve a single subkey from AES encryption engine. In terms of security hardness, this means that LFSR-based S-box according to an example embodiment has outperformed the conventional S-box design using LUT or CFA. LFSR-based S-box according to an example embodiment also advantageously provides speed improvement through multiple initialization seeds that the reduced the overall latency to at least 75% in comparison to the existing LFSR-based multiplicative inverter over GF(2⁸).

Aspects of the systems and methods described herein, such as the AES/LFSR-based S-box implementation and analysis, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise.” “comprising.” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above.” “below.” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

### REFERENCES

[1] M. M. Wong and M. L. D. Wong. New lightweight aes s-box using lfsr. In 2014 International Symposium on Intelligent Signal Processing and Communication Systems (ISPACS), pages 115-120, 2014.
[2] Sourav Das. Halka: A lightweight, software friendly block cipher using ultra-lightweight 8-bit s-box. IACR Cryptology ePrint Archive, 2014:110, 2014.
[3] Sourav Das. Ultra-lightweight 8-bit multiplicative inverse based s-box using lfsr. IACR Cryptology ePrint Archive, 2014:22, 2014.
[4] M. M. Wong and M. L. D. Wong. Lfsr based s-box for lightweight cryptographic implementation. In 2015 IEEE International Conference on Consumer Electronics-Taiwan, pages 498-499, 2015.

1. An Advanced Encryption Standard (AES) cryptographic system comprising:
a SubBytes transformation unit, S-box;
a ShiftRow transformation unit;
a MixColumn transformation unit; and
an AddRoundKey transformation unit;
wherein the S-box comprises two forward-reverse linear-feedback shift registers, LFSRs, pairs for performing multiplicative inversion; and
wherein different respective initialization seeds are used for the pairs of forward-reverse LFSRs.

2. The cryptographic system of claim 1, wherein each LFSR comprises a plurality of registers and a plurality of exclusive or gates, XORs, for non-zero feedback taps.

3. The cryptographic system of claim 2, wherein each LFSR comprises eight registers and three XORs for the non-zero feedback taps.

4. The cryptographic system of claim 1, wherein the two pairs of forward-reverse LFTRs are executed concurrently for performing the multiplicative inversion.

5. The cryptographic system of claim 4, wherein the multiplicative inversion is completed within 63 clock cycles.

6. The cryptographic system of claim 4, wherein peaks in an amplitude versus sampling point traces plot during performing the multiplicative inversion are masked.

7. The cryptographic system of claim 4, wherein a Minimum Traces Disclosure plot for correct key guess exceeds 180 k traces.

8. The cryptographic system of claim 1, wherein the different respective initialization seeds comprise {0x01, 0x01} and {0xCC, 0x85}.

9. The cryptographic system of claim 1, wherein the different respective initialization seeds comprise {0x01, 0x01} and {0x5F, 0x41}.

10. A method of performing Advanced Encryption Standard (AES) cryptography, comprising the steps of:
performing multiplicative inversion for SubBytes transformation using two forward-reverse linear-feedback shift registers, LFSRs, pairs; and
using different respective initialization seeds for the pairs of forward-reverse LFSRs.

11. The method of claim 10, wherein each LFSR comprises a plurality of registers and a plurality of exclusive or gates, XORs, for non-zero feedback taps.

12. The method of claim 11, wherein each LFSR comprises eight registers and three XORs for the non-zero feedback taps.

13. The method of claim 10, comprising executing the two pairs of forward-reverse LFTRs concurrently for performing the multiplicative inversion.

14. The method of claim 13, wherein the multiplicative inversion is completed within 63 clock cycles.

15. The method of claim 13, wherein peaks in an amplitude versus sampling point traces plot during performing the multiplicative inversion are masked.

16. The method of claim 13, wherein a Minimum Traces Disclosure plot for correct key guess exceeds 180 k traces.

17. The method of claim 10, wherein the different respective initialization seeds used comprise {0x01, 0x01} and {0xCC, 0x85}.

18. The method of claim 10, wherein the different respective initialization seeds used comprise {0x01, 0x01} and {0x5F, 0x41}.
